(19) United States
(12) Patent Application Publication
(10) Pub. No.: US 2025/0162477 A1
(43) Pub. Date: May 22, 2025

(54) SYSTEM FOR REGULATING TEMPERATURE AND AIRFLOW INTEGRATED IN VEHICLE SEAT

(71) Applicant: TOYOTA BOSHOKU AMERICA, Novi, MI (US)

(72) Inventors: Vijayavel Ramachandran, Canton, MI (US); Jacob Richter, Livonia, MI (US)

(73) Assignee: TOYOTA BOSHOKU AMERICA, Novi, MI (US)

(21) Appl. No.: 18/953,402

(22) Filed: Nov. 20, 2024

Related U.S. Application Data
(60) Provisional application No. 63/601,153, filed on Nov. 20, 2023.

(51) Int. Cl. B60N 2/56; B60N 2/879

(52) U.S. Cl. CPC B60N 2/5671; B60N 2/5614; B60N 2/5642; B60N 2/5657; B60N 2/879

(57) ABSTRACT

A system for selectively providing either a heated or cooled flow of air to the neck area of the seat occupant. A first embodiment of the present invention provides air flow out of adjustable nozzles fitted to each of the head restraint stays. According to this embodiment, air may also flow out of a vent provided in the front of the head restraint. A second embodiment of the present invention provides air flow out of an adjustable vent positioned on the upper portion of the seat back. Waste air is vented through the seat back or the seat base in a direction away from the conditioned air vents. Waste air is vented near the base of the seat back, through both the seat back and the seat base and out of the seat base, or through both the seat back and the seat base and through the vehicle floor.

### CROSS REFERENCE TO RELATED APPLICATION

This application is a U.S. Non-provisional Patent Application of U.S. Provisional Patent Application No. 63/601,153, entitled “System for Regulating Temperature and Airflow Integrated in Vehicle Seat,” filed Nov. 20, 2023, which is herein incorporated by reference in its entirety for all purposes.

### DESCRIPTION OF THE INVENTION

### Technical Field

The disclosed inventive concept relates generally to seats for use in various modes of transportation. More particularly, the disclosed inventive concept relates to a seat have an integrated system for selectively providing either a heated or cooled flow of air directed generally to the neck area of the seat occupant. According to an additional version of the disclosed invention, conditioned air may also or alternatively be pushed through perforations formed in either or both of the seat back and the seat base.

### BACKGROUND OF THE INVENTION

It is well known that seats for vehicles, whether in the automotive, airline, rail, or marine industries, are prone to being hot in the summer and cold in the winter, often leading to passenger discomfort. Efforts at solving the challenge of seats made uncomfortable to occupants due to extremes in ambient air temperature are complicated because of the different materials traditionally used to cover the seats themselves.

Seat designers, typically in the automotive industry, provided a solution to cold vehicle seats by introducing heating elements to both the seat base and the seat back. The heating elements, typically an electric heating coil which functions as a resistor, are situated beneath the passenger-contacting layer of seat material. Thermostats integrally associated with the heating elements are calibrated to prevent overheating.

After heated vehicle seats were developed and proved successful in commercial application, seat designers confronted the challenge of cooling the same seat. Two solutions were found for cooling, one being through ventilation and the other through actual cooling. Seat ventilation relies on fans and ducting fitted within the seat to move ambient vehicle air toward the seat occupant. Perforations formed in the seat covering material allow for the passage of cooling air. The cooling air is either pushed through the perforations or is drawn through the perforations to create a negative airflow relative to the seat occupant.

As an alternative to either pushing or pulling ambient cooling air through the perforations in the seat covering material, refrigerated air may be forced through the seat perforations. Refrigeration of the air in this arrangement is undertaken either by an independent cooling element or by the vehicle's general air conditioning system.

While providing solutions to the conditioning of vehicle seats for both heating and cooling, known solutions to improving comfort to a seat occupant have not been fully developed. Accordingly, there remains room in the technology of seat comfort to provide improvements.

### SUMMARY OF THE INVENTION

The disclosed inventive concept relates generally to seats for use in various modes of transportation. More particularly, the disclosed inventive concept relates to a seat have an integrated system for selectively providing either a heated or cooled flow of air directed generally to the neck area of the seat occupant. The conditioned air may selectively exhaust from the head restraint, the head restraint support stays, the upper portion of the seat back, or from two or three areas.

The seat of the present invention is presented in two related embodiments. According to the first embodiment of the present invention, air flows out of adjustable nozzles fitted to each of the head restraint stays. In addition, or as an alternative to air flow through the nozzles fitted to the stays, air may also flow out of a vent provided in the front of the head restraint.

According to the second embodiment of the present invention, air flows out of an adjustable vent positioned on the upper portion of the occupant-facing side of the seat back. The second embodiment of the invention can be provided in combination with either one or both air flow alternatives set forth above with respect to the first embodiment of the present invention.

Hot or cold waste air is vented through the seat back or the seat base in a direction away from the conditioned air vents. The ducting provides for waste air to be vented near the base of the back side of the seat back, through both the seat back and the seat base and out of the underside of the seat base, or through both the seat back and the seat base and through the vehicle floor for expulsion out of the vehicle.

According to the second embodiment of the present invention, conditioned air may be pushed through perforations formed in either the seat back or the seat base or both. The conditioned air, either hot or cold, passes through channels formed in the seat back or seat base foam and dispersed through the seat trim cover through perforations.

Other advantages and features of the embodiments of the invention will become apparent when viewed in light of the detailed description of the preferred embodiment when taken in conjunction with the attached drawings and the appended claims.

### BRIEF DESCRIPTION OF THE DRAWINGS

For a more complete understanding of this invention, reference should now be made to the embodiment illustrated in greater detail in the accompanying drawings and described below by way of examples of the invention wherein:

FIG. 1 is a perspective view of a seat having the system for selectively providing heated or cooled flow air to the neck area of the seat occupant according to a first embodiment of the present invention;

FIG. 2 is a side view of the seat illustrated in FIG. 1 shown in partial sectional view to illustrate a first embodiment of the ducting for directing waste air out of the seat;

FIG. 3 is also a side view of the seat illustrated in FIG. 1 shown in partial sectional view to illustrate a second embodiment of the ducting for directing waste air out of the seat;

FIG. 4 is an additional side view of the seat illustrated in FIG. 1 shown in partial sectional view to illustrate a third embodiment of the ducting for directing waste air out of the seat;

FIG. 5 is a perspective view of the head restraint of the seat of FIG. 1 but including optional air directing nozzles;

FIG. 6 is a perspective view of a seat having the system for selectively providing heated or cooled flow air to the neck area of the seat occupant according to a second embodiment of the present invention; and

FIG. 7 is a side view of the seat illustrated in FIG. 6 shown in partial sectional view to illustrate a first embodiment of the ducting for directing waste air out of the seat; and

FIG. 8 is a side view of an additional embodiment of the seat of the disclosed invention illustrating conditioned air issuing from the seat back and the seat base in addition to the head restraint and the head restraint stays.

### DETAILED DESCRIPTION OF THE PREFERRED EMBODIMENT

In the following figures, the same reference numerals will be used to refer to the same components. In the following description, various operating parameters and components are described for one constructed embodiment. These specific parameters and components are included as examples and are not meant to be limiting.

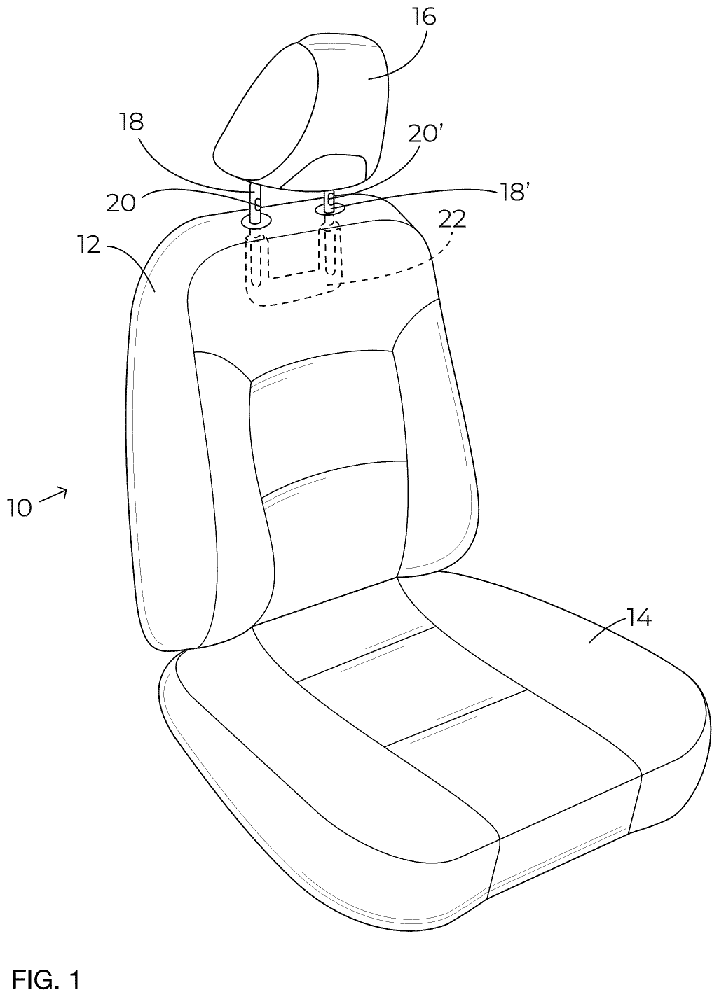

Referring to FIG. 1, a perspective view of a seat of the disclosed inventive concept is shown. It is to be understood that the seat disclosed and discussed may have application in any mode of transportation and is thus not limited to automotive vehicles. The seat, generally illustrated as 10, includes a seat back 12 and a seat base 14. The seat 10 is shown for illustrative purposes only. The shapes and sizes of the seat back 12 and the seat base 14 as illustrated are not intended as being limiting.

The seat 10 includes a head restraint 16 attached to the seat back 12 by a pair of head restraint stays 18 and 18′. As is conventionally known, the head restraint stays 18 and 18′ allow up and down movement of the head restraint 16 relative to the seat back 12 to provide optimum comfort for the seat occupant.

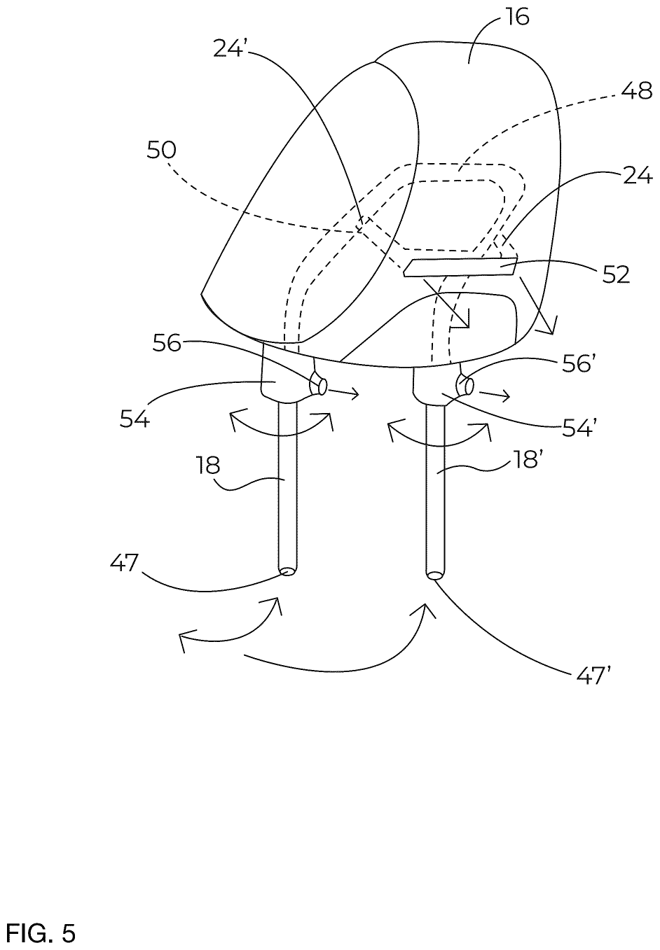

Each of the head restraint stays includes an aperture to allow for the flow of air out of the head restraint stays 18 and 18′ and toward the neck area of the passenger. More particularly, an air flow aperture 20 is formed in the head restraint stay 18 and an air flow aperture 20′ is formed in the head restraint stay 18′. The apertures 20 and 20′ are formed continuous with a hollow core formed in the head restraint stays 18 and 18′. The hollow core may be formed only in the stays 18 and 18′ or, as head restraint stays are generally formed from a single stay piece (as illustrated below in FIG. 5), the hollow core may be formed through the entire length of the single stay. Regardless of the construction of the head restraint stay, each of the stays 18 and 18′ have an aperture discussed in conjunction with FIG. 5 formed in the base end that is continuous with the hollow core.

An air plenum 22 is formed in the upper end of the seat back 12. The open ends of each of the head restraint stays 18 and 18′ are positioned in the air plenum 22 regardless of the position of the head restraint 16, the open ends of the head restraint stays 18 and 18′ are in fluid communication with the air in the air plenum 22.

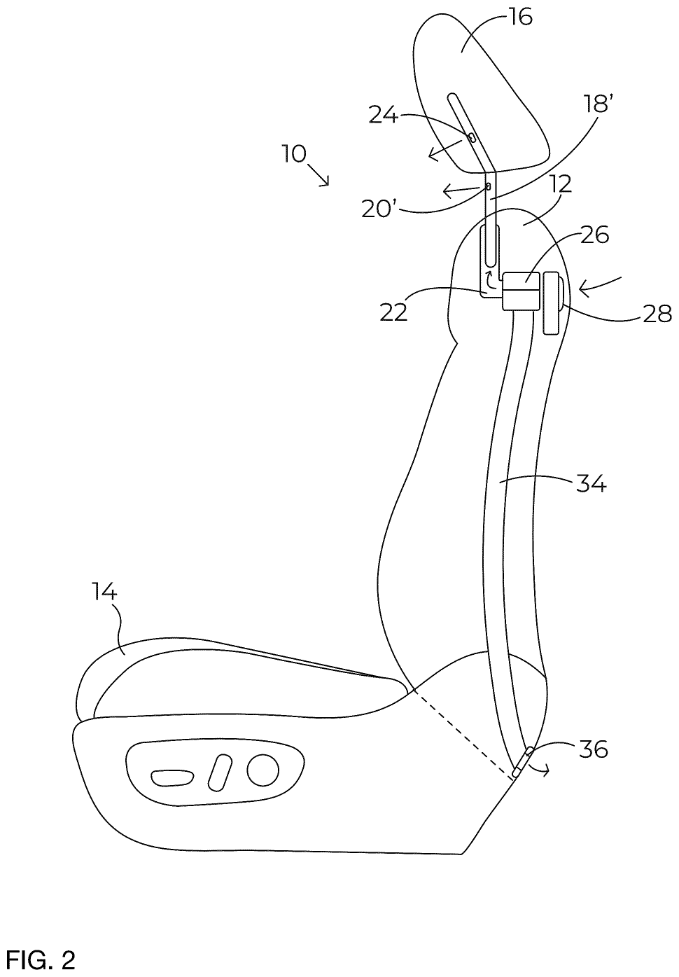

Referring to FIG. 2, a partial sectional side view of the seat 10 is illustrated. As shown, the head restraint stay 18′ includes an aperture 24 provided for optional head restraint cooling as shown in FIG. 5 and as discussed in conjunction therewith. FIG. 2 also illustrates a thermoelectric blower assembly 26 which provides either hot or cold air for use in the disclosed seat system. The blower assembly 26 includes an ambient air intake 28 for drawing in ambient air to be conditioned. While the blower assembly 26 is illustrated as being positioned in the upper portion of the seat back 12, it is to be understood that the blower assembly 26 can be positioned virtually anywhere in the seat 10 and may be ducted to support all of the illustrated embodiments.

Hot waste air (where the seat 10 is being cooled) or cold waste air (where the seat 10 is being heated) is directed away from the blower assembly 26 by ducting which directs the waste air out of the seat 10. Three embodiments of the waste air ducting are provided. The ducting illustrated in FIG. 2 provides one arrangement. As shown, ducting 34 is provided through the seat back 12. The ducting 34 is attached at its upper end to the blower assembly 26. The lower end of the ducting 34 is attached to an outlet 36 which vents the waste air through the seat lower end of the seat back 12.

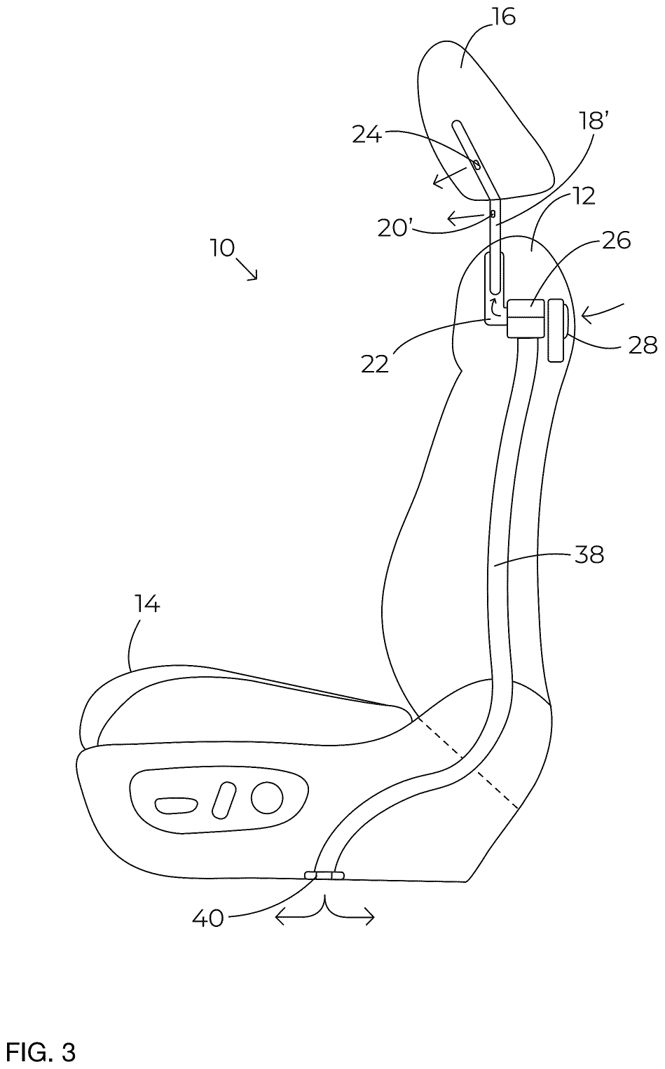

A second embodiment of the waste air ducting arrangement of the disclosed invention is illustrated in FIG. 3. As illustrated, ducting 38 is provided through the seat back 12 and through the seat base 14. The ducting 38 is attached at its upper end to the blower assembly 26. The lower end of the ducting 38 is attached to an outlet 40. According to the waste air flow arrangement of FIG. 3, the waste air travels through both the seat back 12 and the seat base 14 to be expelled under the seat 10.

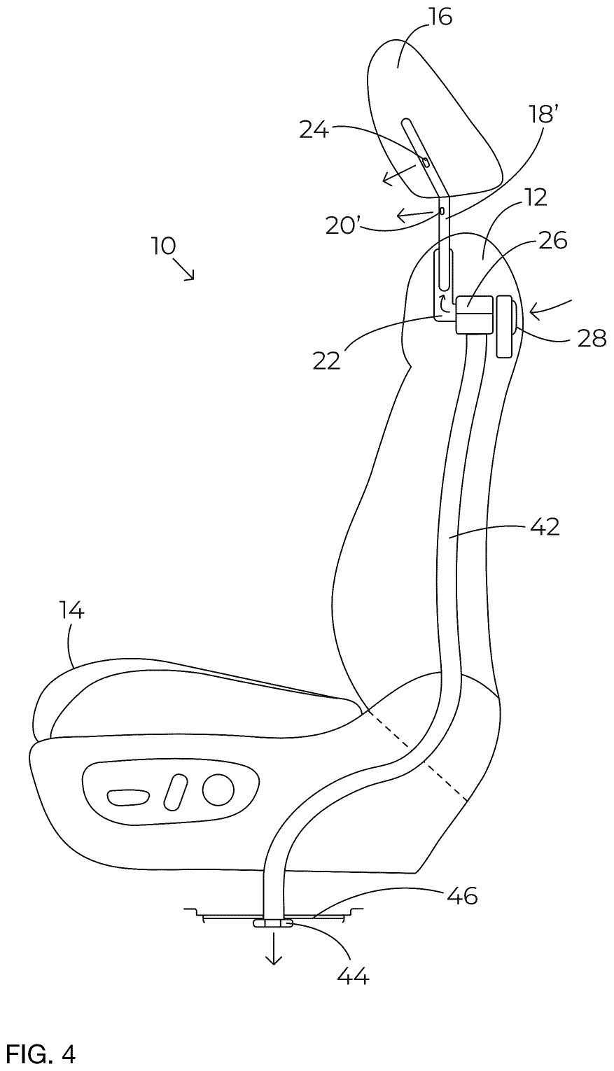

A third embodiment of the waste air ducting arrangement of the disclosed invention is illustrated in FIG. 4. As illustrated, ducting 42 is provided through the seat back 12 and through the seat base 14. The ducting 38 is attached at its upper end to the blower assembly 26. The lower end of the ducting 42 is attached to an outlet 44 which is fitted to the vehicle floor 46. According to the waste air flow arrangement of FIG. 4, the waste air travels through both the seat back 12 and the seat base 14 to be expelled through the vehicle floor 46 to the exterior of the vehicle (not shown).

A perspective view of the head restraint 16 is illustrated in FIG. 5. The head restraint stays 18 and 18′ include air flow apertures 47 and 47′ respectively which allow for air to flow from the plenum 22. As shown, the head restraint stays 18 and 18′ are continuous with one another by way of a connecting tube 48 illustrated in broken lines. According to the present invention, the head restraint stays 18 and 18′ may be independent of one another or, as illustrated in FIG. 5, may be continuous with one another. According to the latter arrangement, an extension tube 50 shown in broken lines is provided to allow flowing air to enter and exhaust from a head restraint vent 52 formed from shaped head restraint foam. The extension tube 50 is fluidly associated with the connecting tube 48 by tube extensions 24 and 24′ illustrated in broken lines

The air flowing from the apertures 20 and 20′ formed in the head restraint stays 18 and 18′ respectively may optionally be selectively directed to the occupant's neck through air nozzles 54 and 54′. A variety of arrangements may be used for directing the air. One suggested arrangement is illustrate in FIG. 5 in which a flow direction outlet 56 is movably attached to the nozzle 54 and a flow direction outlet 56′ is movably attached to the nozzle 54′. Preferably the outlets 56 and 56′ are movable relative to the nozzles 54 and 54′ so as to deliver air in any one of several directions, including up/down and side-to-side. The outlets 56 and 56′ may be attached to the nozzles 54 and 54′ respectively such as by a ball-and-socket arrangement which is one of several possible arrangements.

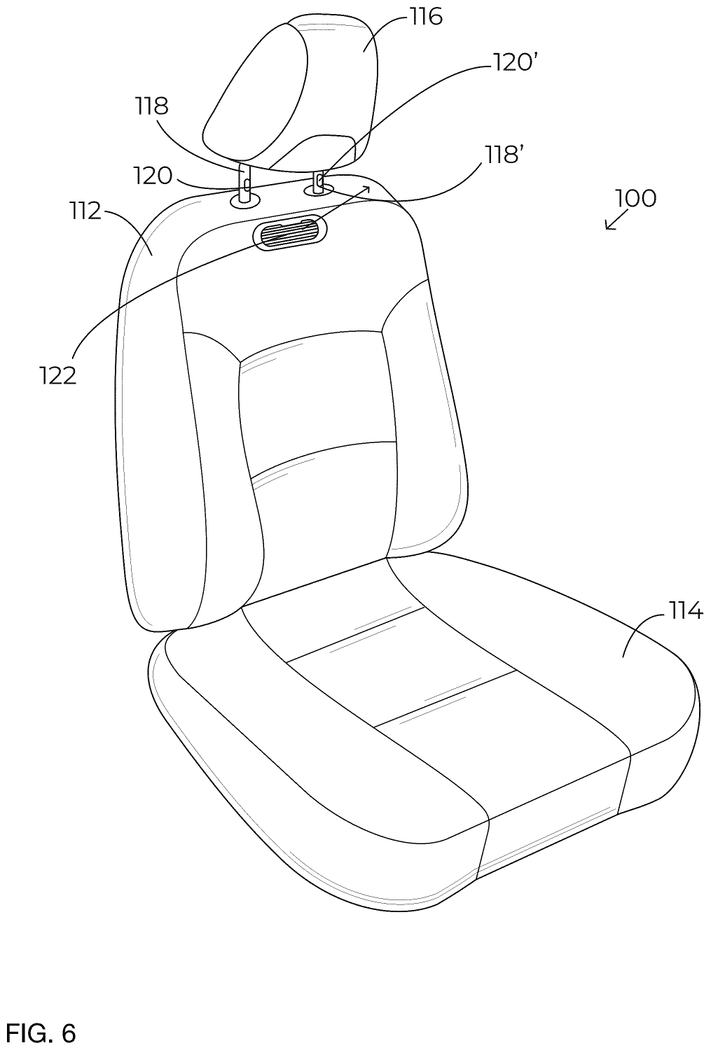

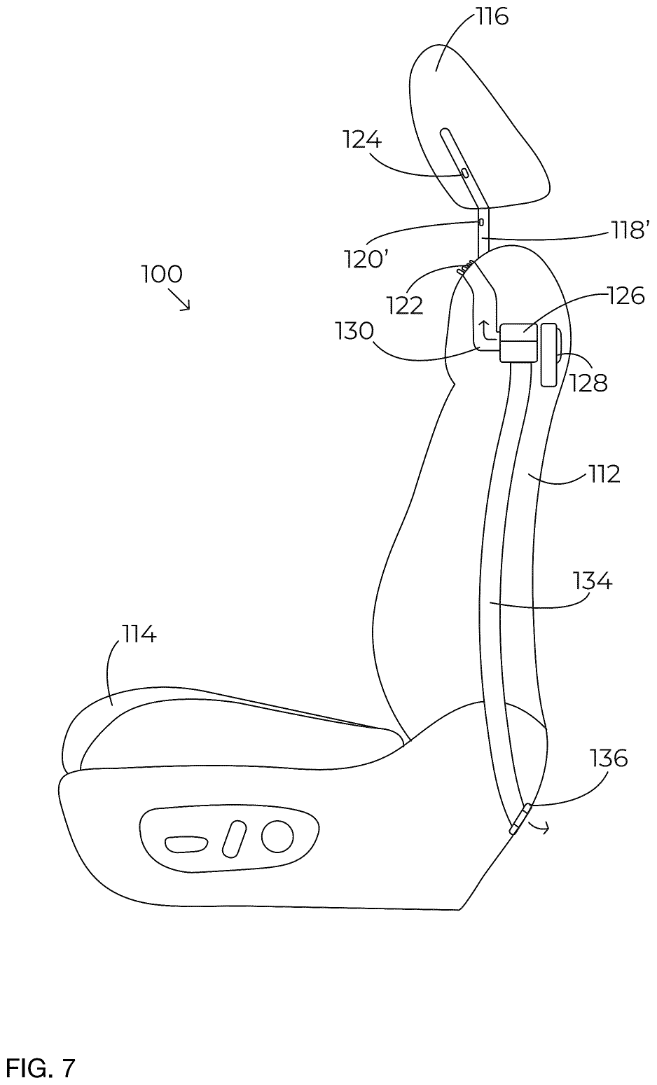

Arrangements for providing conditioned air to the neck area of a seated passenger other the constructions discussed in relation to FIGS. 1 through 5 are possible. One such alternative arrangement or second embodiment is shown in FIGS. 6 and 7. As shown in FIG. 6, a perspective view of a seat, generally illustrated as 100 and having an alternative conditioned air flow arrangement, is illustrated. The seat 100 includes a seat back 112, a seat base 114, and a head restraint 116. The head restraint 116 is attached to the seat back 112 by head restraint stays 118 and 118′. The head restraint stay 118 preferably includes a conditioned air aperture 120 and the head restraint stay 118′ preferably includes a conditioned air aperture 120′. The conditioned air apertures 120 and 120′, when provided, operate in the same manner as discussed above with respect to the embodiment of the present invention shown in FIGS. 1 through 5 and discussed in conjunction therewith.

The embodiment of the present invention illustrated in FIGS. 6 and 7 includes a vent 122 positioned in the upper end of the front side of the seat back 112. The vent 122 is preferably louvered to thereby allow air flow to be directed in a variety of directions, including but not limited to up/down and side-to-side. Other air flow-directing arrangements are possible, such as nozzles.

As shown in FIG. 7 in which a side view of the seat 100 is illustrated in partial sectional, a blower assembly 126 is provided in the seat back 112. An ambient air intake 128 is provided in the back side of the blower assembly 126. The vent 122 is attached to a plenum 130 which may or may not also be fluidly associated with the head restraint stays 118 and 118′. It is to be understood that the first and second embodiments of the disclosed invention may be provided separately or may be provided in the same seat arrangement.

Waste air is exhausted away from the blower assembly 126 by an exhaust duct 134 provided through the seat back 112. The ducting 134 is attached at its upper end to the blower assembly 126. The lower end of the ducting 134 is attached to an outlet 136 which vents the waste air through the seat lower end of the seat back 112. This arrangement is consistent with the waste air system of FIG. 2 in relation to the first embodiment of the present invention. It is to be understood that the waste air ducting arrangements of FIGS. 3 and 4 which are alternatives for the first embodiment may also be used as alternative waste air ducting arrangements for the second embodiment of the disclosed invention.

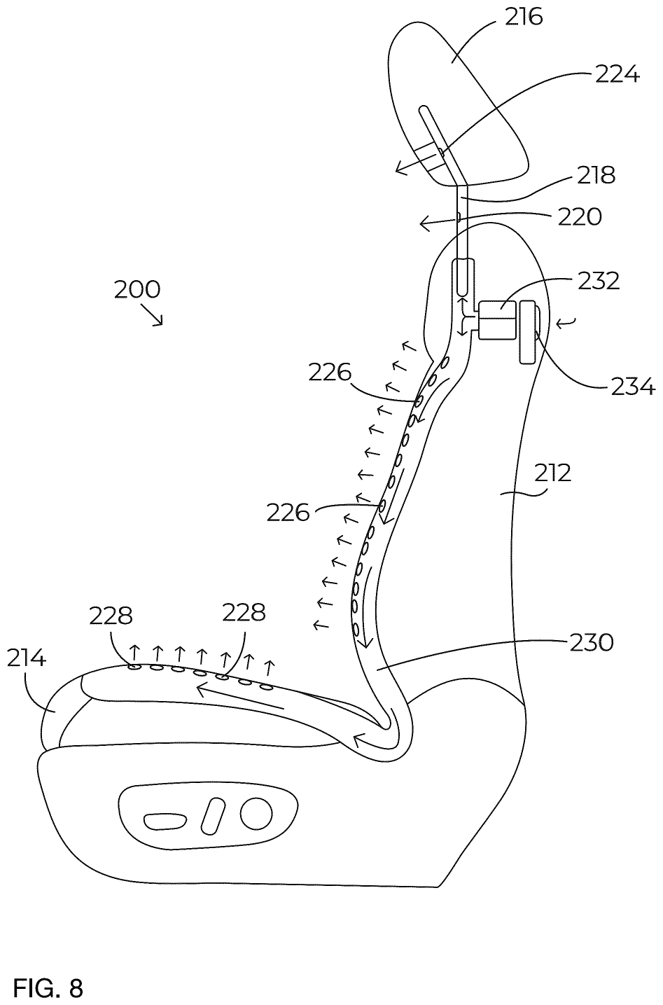

Referring to FIG. 8, a partial sectional side view of a seat 200 according to a third embodiment of the present invention is illustrated. The seat 200 includes a seat back 212, a seat base 214, and a head restraint 216. A pair of head restraint stays of which stay 218 is visible are provided to attach the head restraint 216 to the seat back 212. The head restraint stay 218 may include an aperture 220 for conditioning the seat occupant's neck as discussed above in relation to the first and second embodiments of the present invention. An additional aperture 224 may be provided, also as discussed above.

According to the third embodiment of the present invention illustrated in FIG. 8, conditioned air is forced through a series of perforations 226 formed in the seat back 212 and/or through a series of perforations 228 formed in the seat base 214. Preferably though not exclusively, the perforations 226 and the perforations 228 are in fluid communication with a channel 230 formed in the foam of the seat back 212 and the seat base 214. In addition to the positive ventilation of conditioned air through the perforations 226 and 228 of the seat back 212 and the seat base 214 respectively by way of the channel 230, conditioned air is also directed to the head restraint stay 218 through the channel 230. The channel 230 is in fluid communication with a thermoelectric blower assembly 232. An ambient air intake 234 for drawing in ambient air is provided on the blower assembly 232. According to the third embodiment, either or both the seat back 212 and the seat base 214 may be air conditioned.

It is to be understood that the air-conditioned seat back 212 and seat base 214 illustrated in FIG. 8 may be provided either independent of or in combination with the air-conditioned head restraint 216 and head restraint stay 218. In addition, the air-conditioned head restraint and upper seat back of the first and second embodiments of the present invention may be provided independent of or as an alternative to the third embodiment of the present invention shown in FIG. 8 and discussed in conjunction therewith.

The foregoing discussion discloses and describes an exemplary embodiment of the present invention. One skilled in the art will readily recognize from such discussion, and from the accompanying drawings that various changes, modifications and embodiments can be made therein without departing from the true spirit and fair scope of the invention.

What is claimed:

1. A seat for a vehicle having an integrated system for heating or cooling a seat occupant, the seat comprising:
a seat base;
a seat back attached to the seat base, the seat back including an upper end, the upper end including an air plenum;
a head restraint attached to the seat base, the head restraint including at least one head restraint support stay connecting the head restraint to the seat back, the at least one stay having an inner core, the inner core being substantially hollow, the at least one stay being in fluid communication with the air plenum.

2. The seat for a vehicle of claim 1, wherein the at least one stay having at least one air flow aperture formed therein, the at least one air flow aperture being in fluid communication with the inner core of the at least one stay.

3. The seat for a vehicle of claim 2, wherein the at least one stay includes a nozzle.

4. The seat for a vehicle of claim 3, wherein the nozzle has an inner surface, the inner surface being rotatable on the at least one stay.

5. The seat for a vehicle of claim 1, wherein the seat back further includes an air blower assembly fluidly attached to the air plenum.

6. The seat for a vehicle of claim 5, wherein the seat back further includes ducting, the ducting having a first end connected to the air blower assembly and a second end.

7. The seat for a vehicle of claim 6, wherein the seat back has a lower end and wherein the second end of the ducting exhausts outside of the seat back at a point in the lower end of the seat back.

8. The seat for a vehicle of claim 7, wherein the seat base has an underside and wherein the second end of the ducting exhausts outside of the seat base at a point on the underside of the seat base.

9. The seat for a vehicle of claim 7, wherein the vehicle includes a floor having an underside, and wherein the ducting exhausts outside of the vehicle at a point on the underside of the floor.

10. The seat for a vehicle of claim 1, wherein the head restraint further includes a restraint vent in fluid communication with the at least one stay.

11. The seat for a vehicle of claim 1, wherein the upper end of the seat back includes a seat vent in fluid communication with the air plenum.

12. The set for a vehicle of claim 1, wherein the seat back includes a front, and wherein the seat base includes an upper surface, the seat further including a seat back channel fitted proximate the upper surface of the seat back front and a seat base channel fitted proximate the upper surface of the seat base, the seat back channel being in fluid communication with the air blower and the seat base channel being in fluid communication with the seat back channel, and wherein the seat back channel and the seat base channel have air-passing perforations formed therein.

13. A neck cooling arrangement integrated into a seat for cooling the neck area of a seat occupant, the seat comprising:
a seat base;
a seat back attached to the seat base, the seat back including an upper end, the upper end including an air blower;
at least one head restraint stay;
a head restraint attached to the seat base by the at least one head restraint stay; and
a directed cooling system being selected from the group consisting of the at least one head restraint stay wherein the at least one head restraint stay is substantially hollow with at least one air hole formed therein, a vent formed in the head restraint and fluidly associated with the at least one air hole formed in the at least one head restraint stay, and a seat back vent formed in the upper end of the seat back, the seat back vent being fluidly associated with the air blower.

14. The neck cooling arrangement of claim 13, further including an air plenum formed in the upper end of the seat back, the air blower being fluidly associated with the air plenum.

15. The neck cooling arrangement of claim 14, wherein the at least one head restraint stay is fluidly associated with the air plenum.

16. The neck cooling arrangement of claim 13, wherein the at least one head restraint stay includes a nozzle.

17. The neck cooling arrangement of claim 16, wherein the nozzle has an inner surface, the inner surface being rotatable on the at least one stay.

18. A method of cooling the neck area of an occupant seated in a vehicle seat, the method comprising:
forming an integrated seat system comprising a seat base, a seat back attached to the seat base, the seat back having an upper end, at least one head restraint stay attached to the upper end of the seat back, a substantially hollow head restraint attached to the at least one head restraint stay, a plenum formed in the upper end of the seat back, and an air blower positioned at least partially within the upper end of the seat back, and at least one air vent selected from the group consisting of at least one air vent hole formed in the at least one head restraint stay, a vent positioned in the upper end of the seat back, and a vent formed in the head restraint.

19. The method of cooling the neck area of an occupant seated in a vehicle seat of claim 18, wherein the vent positioned in the upper end of the seat back is fluidly associated with the air plenum.

20. The method of cooling the neck area of an occupant seated in a vehicle seat of claim 18, wherein the vent formed in the head restraint is fluidly associated with the at least one air vent formed in the at least one head restraint stay.
